(19) United States
(12) Patent Application Publication
(10) Pub. No.: US 2005/0217158 A1
(43) Pub. Date: Oct. 6, 2005

(54) Reusable planner

(76) Inventor: George L. Gamby, Winnipeg (CA)

Correspondence Address: ADE & COMPANY, 1700-360 MAIN STREET, WINNIPEG, MB, R3C3Z3, CA

(21) Appl. No.: 11/032,216

(22) Filed: Jan. 11, 2005

Related U.S. Application Data
(60) Provisional application No. 60/558,138, filed on Apr. 1, 2004.

(51) Int. Cl. G09F 3/18

(52) U.S. Cl. 40/661.01

(57) ABSTRACT

The planner comprises a pair of cover members foldable relative to one another which include confronting inner surfaces for writing reminder notes and the like thereon. One or both of the inner surfaces comprises a rewritable surface for use with water soluble or dry eraser ink. Magnetic materials on one or both of the cover members permit attachment to a ferromagnetic surface, for example a fridge, in either open or closed positions of the cover member. One of the cover members includes a recess for mounting a photo therein or some other card like item to be displayed so that the notations on the inner surfaces are hidden from view and disguised in an attractive manner by the photo.

### FIELD OF THE INVENTION

The present invention relates to a reusable planner including a rewritable surface and magnetic mounting for mounting on a refrigerator and the like.

### BACKGROUND

People have a need to make lists for a variety of applications and refer to them when in a store, or in a workplace.

Various examples of planners are related devices are described in U.S. Pat. No. 6,364,162 (Enriquez); U.S. Pat. No. 6,250,006 (Berrier); U.S. Pat. No. 6,435,560 (Pruner); U.S. Pat. No. 4,034,539 (Economy); U.S. Pat. No. 4,274,567 (Sawyer) and U.S. Pat. No. 5,303,489 (Blegen).

Known designs of planners permit limited use, are unattractive to display and provide no motivation to use regularly.

### SUMMARY

According to one aspect of the present invention there is provided a planner comprising:

a pair of cover members each including a displayable inner surface, the cover members being coupled for folding movement relative to one another between a closed position in which the inner surfaces confront one another directly adjacent one another and an open position in which the inner surfaces are juxtaposed in a generally common plane; and

a magnetic material secured to at least one of the cover members for supporting the cover members on a ferromagnetic supporting surface;

at least one of the displayable inner surfaces comprising a rewritable surface.

The attached pen will make it easy to make shopping or to-do lists, and identify any items, which have been purchased, saving time, and ensuring that all of the items have been purchased.

The rewritable surfaces look like paper so it is not foreign to the user. A water soluble, fine-tipped pen, or dry-erase pen allows a person to use it in a natural manner.

The personalized photograph on the front cover will ensure that the device is mounted on the fridge. Most refrigerator doors are covered with pictures of the family, friends, pets, etc. so the device will fit in.

The foldable nature of the device doubles the amount of writing space and allows it to be closed when not in use. It will not look like a list.

Space on the top front cover will be welcomed by marketers looking for high repeat visibility, 20 to 30 times per day, every time the fridge door is opened, and association with a highly functional product. Some useful markets to which the planner may be a desirable form of advertising include take-out restaurants, banking and financial service companies, non-profit groups for fund-raising, major retailers, auto dealers, auto services, NFL and other sports team logos or NASCAR.

In one embodiment, both displayable inner surfaces comprise a rewriteable surface, however one of the surface may support a pad of self stick note paper thereon or may include printed information thereon.

Preferably, the magnetic material is secured to both of the cover members for supporting the planner on a ferromagnetic surface in both open and closed positions.

There may be provided a recessed opening formed in an outer surface of one of the cover members opposite the inner surface thereof for displaying a flat card like item therein, for examples photos or other advertising material as described herein. The recessed opening is preferably offset in a lengthwise direction towards one end of the respective cover member to define a free space on the outer surface of the cover member adjacent the recessed opening for printed information. The magnetic material is preferably about a periphery of the recessed opening.

There may be provided a clear plastic cover for retaining the item within the recess in which the cover includes tabs on opposing edges receivable within respective slots formed in opposing edges of the recess.

Preferably there is provided a receptacle on one of the inner surfaces for supporting a pen therein in which the receptacle is oriented to support the pen extending parallel to a hinge between the cover members with an open end of the receptacle which receives the pen facing upwardly. Accordingly, the pen is pointed downward with ink being drawn to the tip when the pen is received in the receptacle and the planner is supported in an upright orientation on an upright supporting surface, for example a fridge door.

The receptacle may be formed for receiving a conventional pen cap therein and may include a retaining mechanism for retaining the pen cap therein once received in the receptacle.

Preferably the receptacle is supported adjacent a free edge of one of the cover members.

The cover members each include a peripheral flange which projects inwardly towards the opposing cover member in a closed position thereof, wherein the peripheral flanges include mating edges for engaging one another to define an enclosure between the inner surfaces when closed.

Each inner surface may include a raised displayable portion comprising a rewritable surface.

The receptacle for supporting a pen alongside the raised portion and corresponding pen supported therein are preferably at least partially recessed in relation to the rewritable surface of the raised portion.

There may be provided a clip for retaining the cover members in the closed position.

### BRIEF DESCRIPTION OF THE DRAWINGS

In the accompanying drawings, which illustrate exemplary embodiments of the present invention:

FIG. 1 is a perspective view of a first embodiment of the planner in an open position.

FIG. 2 is a perspective view of the first embodiment of the planner in a closed position.

FIGS. 3 and 4 are plan views of the planner according to FIG. 1 in the open position and in the closed position respectively.

FIG. 5 is a perspective view of a second embodiment of the planner.

FIG. 6 is a plan view of the planner according to FIG. 5 in an open position.

FIG. 7 is a sectional view along the line 7-7 of FIG. 6.

FIG. 8 is a sectional view along the line 8-8 of FIG. 6.

### DETAILED DESCRIPTION

Referring to the accompanying drawings, there is illustrated a reusable planner generally indicated by reference numeral 10. The planner 10 is particularly suited for use as a shopping list and the like.

While various embodiments are described herein, some of the common features will first be described herein. The planner 10 generally comprises a two-page book, of foldable cover members 11, that is magnetically attached to a refrigerator door with reusable white inner writing surfaces 12, for example a white vinyl. A pen 14 with water-soluble ink is mounted on the spline 16 or side of the book with the cap side down for being received in a receptacle 18, so that the unit may be removed from the refrigerator and referred to by the user in any environment. The book cover has provision for a personalized 3½″×5″ photo in a frame secured by a clear plastic cover. An advertising/brand message space 22 is also provided on the cover. Magnetic materials 24 which support the planner on a ferromagnetic surface, give the effect of a floating picture frame.

The planner may be used for making any list such as grocery, to do lists, phone messages, or holiday shopping lists. The planner may be removed from the refrigerator door and taken to the store, referred to, and with the enclosed pen, mark off items that have been purchased. The water-soluble ink or dry-erase ink is easy to remove for use over and over again.

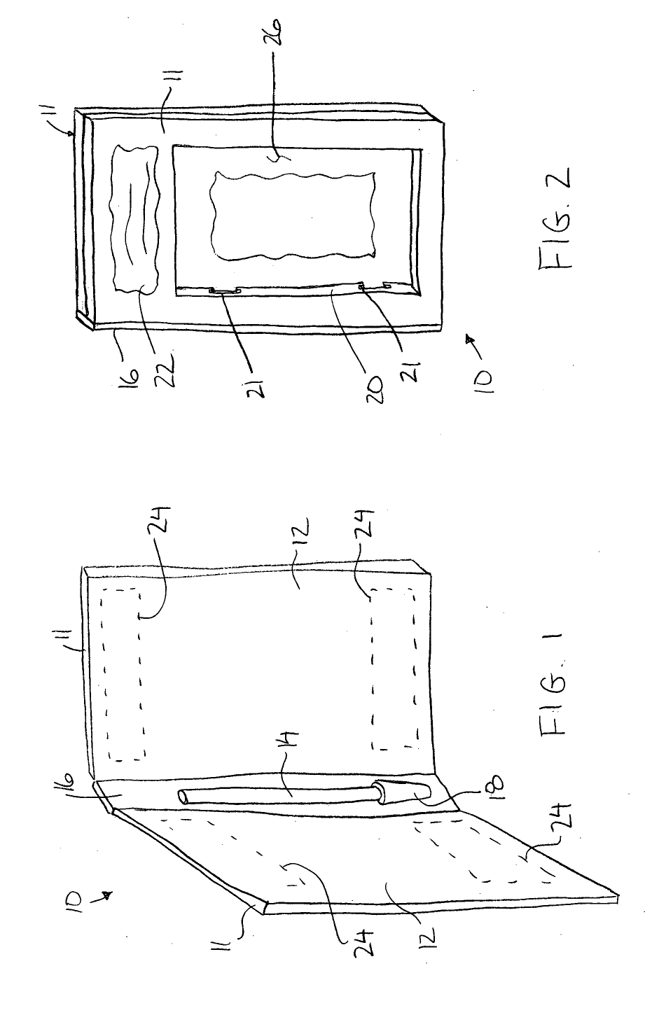

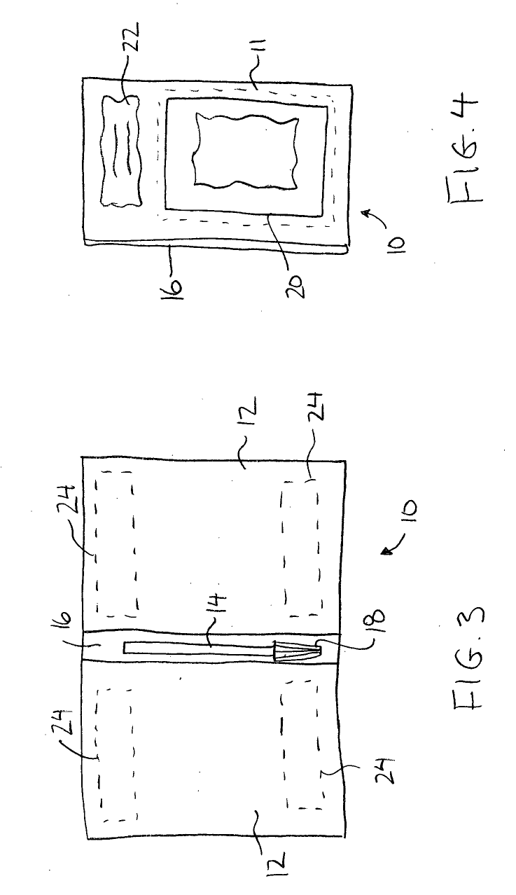

Turning now to the first embodiment of FIGS. 1 through 4, both of the displayable inner surfaces 12 comprise a rewriteable surface when used with water soluble ink or dry erase ink. The corresponding pen 14 is received within the receptacle 18 which is mounted along the spline 16 so that the pen remains well secured within the planner when in the folded and closed position.

The recess 20 for receiving a photo therein on the front cover is held in place by a clear cover 26 which is retained by tabs received in slots 21 at the sides of the recess. The magnetic material 24 is embedded within both the front and rear covers to be hidden from view on the inside surfaces, thus maximizing the writeable surface area on the inner surfaces.

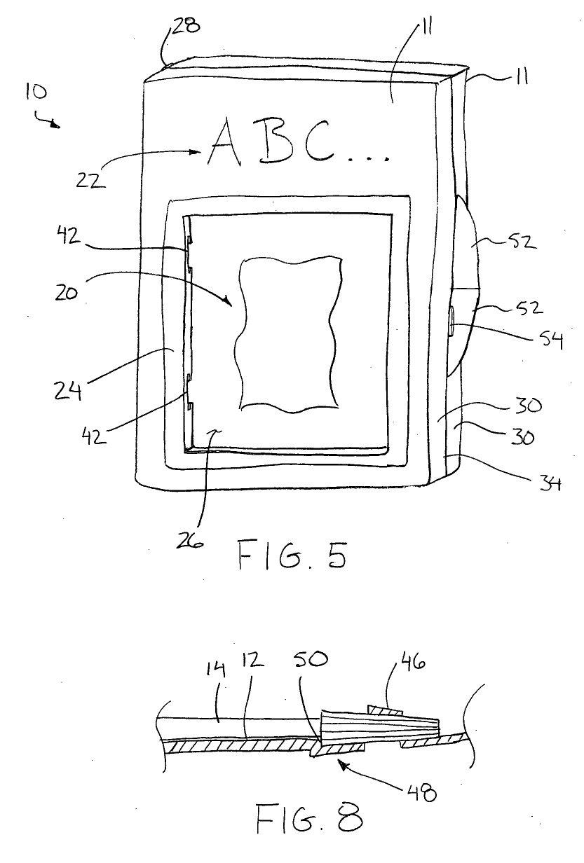

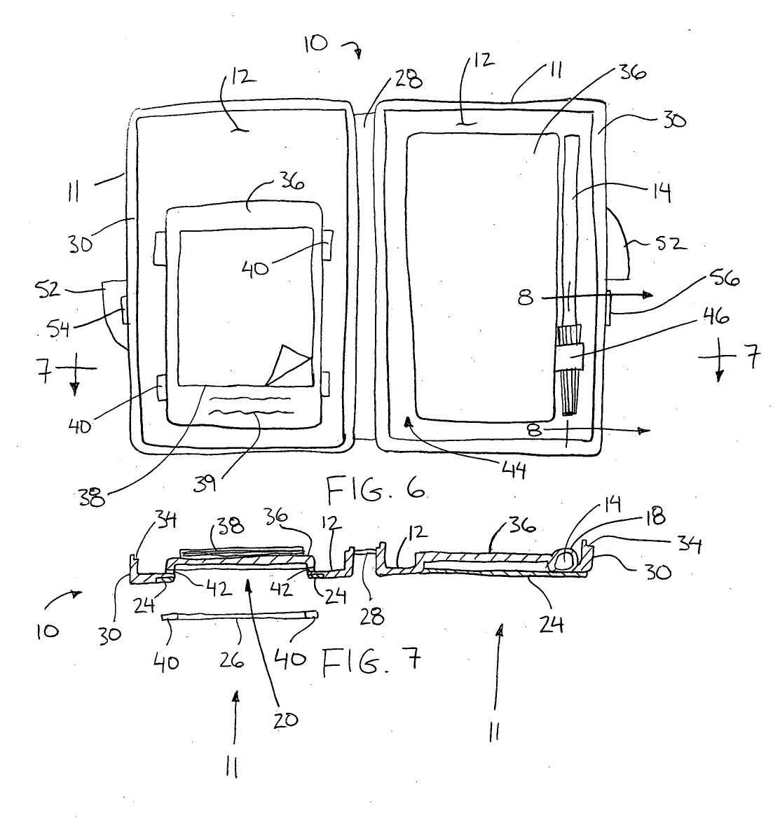

Turning now to the second embodiment, as illustrated in FIGS. 5 through 8, the cover members 11 of the planner are integrally moulded with one another of a substantially rigid plastic material. The cover members are coupled by a hinge 28, also integrally moulded therewith of plastic material, which has a small enough thickness so as to permit flexing pivotal movement of the cover members relative to one another between the open position of FIGS. 6 and 7 and the closed position of FIG. 5.

Each cover member includes a peripheral flange 30 which is raised inwardly, substantially perpendicularly to the inner surface 12. Inner edges 34 of the peripheral flange 30 are configured for mating with one another when the cover is in the closed position so that a portion of each flange overlaps the corresponding flange in a snap fit configuration.

Each inner surface 12 includes a raised displayable portion 36 having a height which is near the height of the flanges from the inner surface 12. As illustrated a note pad 38 of self sticking note paper is mounted on one of the raised displayable portions 36 on the front cover wherein the height of this portion 36 is substantially reduced is relation to the flanges to accommodate for the thickness of the note pad. Printed information 39 is also provided on one of the portions 36, in the form of an advertising message or useful contact information for example.

The raised portion 36 on the inner surface of the front cover corresponds to the recess 20 on the front outer surface of the planner. The recess 20 is rectangular in shape and recessed inwardly from the outer surface. The magnetic materials 24 are formed about a periphery of the recess for framing the picture in an attractive manner while remaining functional for securing the front cover member 11 to a ferromagnetic surface when the planner is in the open position.

The recess 20, and accordingly the corresponding raised displayable portion 36 on the inner surface are each offset in the lengthwise direction of the cover member towards one end to define the free space 22 on the outer side for receiving printed information, for example an advertising message or brand information.

A photo or other card like panel with information to be displayed thereon is retained within the recess by a clear cover 26 which fits within the perimeter of the recess and includes tabs 40 projecting from opposing side edges thereof for being received within respective slots 42 located within the side edges of the periphery of the recess. The cover 26 is flexible for removal by flexing the cover until the tabs can be withdrawn from the respective slots 42.

The raised displayable portion 36 on the rear cover member 11 extends substantially a full length of the cover member with the exception of a small gap 44 about a periphery thereof between the raised displayable portion 36 and the peripheral flange 30. The receptacle 18 for mounting the pen therein is received within this gap 18 adjacent an outer free edge of the cover member so as to be parallel to the hinge but spaced therefrom at the free edge. Similarly to the previous embodiment, the receptacle supports a pen cap in an inverted position with the opening of the receptacle facing the top edge in relation to printed material on the cover member so that when a pen is received therein and the planner is supported in an upright manner on a ferromagnetic surface with the printed material being legible and upright, ink will flow downwardly towards the tip of the pen.

The receptacle 18 generally comprises a rigid strap 46 moulded integrally with the cover member and which is sufficiently sized for snugly receiving a conventional pen cap between the strap 46 and the inner surface 12 of the cover member. The inner surface 12 includes a mating portion 48 which confronts the strap 46 to mate with the contours of the pen cap. In particular, the mating portion 48 includes a shoulder 50 formed therein which faces downwardly and is suitably positioned in relation to the strap for engaging a peripheral edge about the opening of the cap so that the cap is retained by the shoulder once inserted between the strap and inner surface of the cover member. Accordingly withdrawal of the pen from the planner causes the cap to engage the shoulder 50 and remain engaged within the receptacle, thus permitting immediate use of the pen instead of requiring further removal of the cap therefrom.

A pair of gripping members 52 is provided on the free edges of the cover members 11 respectively to assist the user in urging the cover member towards each other and way from each other between the open and closed positions. One of the gripping members includes a recess 54 for receiving a mating protrusion 56 on the opposing cover member which is snap fit within the recess 54 in the closed position for retaining the cover members in the closed position. Once closed, the peripheral flanges 30 are mated with one another to define an enclosed space between the inner surfaces 12 of the planner to further ensure that the pen 14 or any loose note paper and the like is retained within the planner when the planner is transported.

As noted above, the planner generally takes the form of a reusable, book-like shopping list that magnetically attaches to the refrigerator door, is foldable, has plasticized or hard writing surfaces, or a sticky-type paper note pad, and has room on the front cover for a picture (so you do not see the list). The front cover, could also include, in lieu of a picture supplied by the consumer, metric conversions, food guide information, or an advertising message. The unit is foldable so you it does not take up a large amount of room on the refrigerator door, and when folded, does not look like a shopping list. The planner also comes with a wet or dry ink, erasable fine-point felt pen, which is mounted top cap down. The top cap is affixed to the planner such that gravity ensures that any available ink within the pen will be directed towards the writing tip received within the inverted receptacle on the planner when stored upright on a refrigerator or other upright surface.

As the unit is magnetically attached to the refrigerator it can be removed, and carried to the store. In that way you can take the list with you, refer to it, and use the pen to mark-off the items that have been purchased. When returned home the writing surfaces are simply wiped down, remounted on the refrigerator, and folded up so that only the picture of choice is visible. This means that the planner looks like a normal picture when not in use.

The design will be such that there will be space on the front cover for an advertising logo. This will be important for any company or organization that is anxious to have their name in the presence of the consumer 24 hours a day.

A typical size of the planer may be 4 inches by 7 inches when folded and accordingly 8 inches by 7 inches when opened.

Some advantages of the present planner include: the customer's own picture or advertising message on the front cover member, in a recessed area secured by a clear plastic cover that is removable via slots; a pen that is mounted vertically with top cap down so as to best make use of available ink; hard writing surface that will permit the use of an erasable pen, or sticky-type paper note pad; a foldable construction so that it does not look like a shopping list and is easy to carry; magnetic mountings for attachment to the refrigerator and room on front cover for advertising logos or messages.

In a preferred embodiment, both inner surfaces include at least a portion of which comprises a rewritable surface usable with water soluble or dry erase ink, however any desirable combination of rewritable surfaces, self stick note pads, printed information or other display surfaces may be used on the inner surfaces of the foldable cover.

While some embodiments of the present invention have been described in the foregoing, it is to be understood that other embodiments are possible within the scope of the invention. The invention is to be considered limited solely by the scope of the appended claims.

1. A planner comprising:
a pair of cover members each including a displayable inner surface, the cover members being coupled for folding movement relative to one another between a closed position in which the inner surfaces confront one another directly adjacent one another and an open position in which the inner surfaces are juxtaposed in a generally common plane; and
a magnetic material secured to at least one of the cover members for supporting the cover members on a ferromagnetic supporting surface;
at least one of the displayable inner surfaces comprising a rewritable surface.

2. The planner according to claim 1 wherein both displayable inner surfaces comprise a rewriteable surface.

3. The planner according to claim 1 wherein one of the displayable inner surfaces supports a pad of self stick note paper thereon.

4. The planner according to claim 1 wherein one of the displayable inner surfaces includes printed information thereon.

5. The planner according to claim 1 wherein a magnetic material is secured to both of the cover members.

6. The planner according to claim 1 wherein there is provided a recessed opening formed in an outer surface of one of the cover members opposite the inner surface thereof for displaying a flat card like item therein.

7. The planner according to claim 6 wherein the recessed opening is offset in a lengthwise direction towards one end of the respective cover member to define a free space on the outer surface of the cover member adjacent the recessed opening.

8. The planner according to claim 6 wherein there is provided a clear plastic cover for retaining the item within the recess, the cover including tabs on opposing edges receivable within respective slots formed in opposing edges of the recess.

9. The planner according to claim 6 wherein there is provided magnetic material about a periphery of the recessed opening.

10. The planner according to claim 1 wherein there is provided a receptacle on one of the inner surfaces for supporting a pen therein.

11. The planner according to claim 10 wherein the receptacle is oriented to support the pen extending parallel to a hinge between the cover members.

12. The planner according to claim 11 wherein the receptacle is oriented such that an open end receiving the pen therein faces upwardly.

13. The planner according to claim 10 wherein the receptacle is formed for receiving a conventional pen cap therein and includes a retaining mechanism for retaining the pen cap therein once received in the receptacle.

14. The planner according to claim 10 wherein the receptacle is supported adjacent a free edge of one of the cover members.

15. The planner according to claim 1 wherein the cover members each include a peripheral flange which projects inwardly towards the opposing cover member in a closed position thereof, wherein the peripheral flanges include mating edges for engaging one another to define an enclosure between the inner surfaces.

16. The planner according to claim 15 wherein each inner surface includes a raised displayable portion which comprises a rewritable surface.

17. The planner according to claim 16 wherein there is provided a receptacle for supporting a pen alongside the raised portion wherein the receptacle and corresponding pen supported therein are partially recessed in relation to the rewritable surface of the raised portion.

18. The planner according to claim 15 wherein there is provided a clip for retaining the cover members in the closed position.
